(19) United States
(12) Patent Application Publication
(10) Pub. No.: US 2021/0189029 A1
(43) Pub. Date: Jun. 24, 2021

(54) Production of Impact Copolymer PolyPropylene Using Metallocene and Ziegler-Natta Catalysts in Parallel Reactors

(71) Applicant: ExxonMobil Chemical Patents Inc., Baytown, TX (US)

(72) Inventors: Yifeng Hong, Houston, TX (US); Jay L. Reimers, Houston, TX (US); Xiaodan Zhang, Houston, TX (US)

(21) Appl. No.: 17/109,229

(22) Filed: Dec. 2, 2020

Related U.S. Application Data
(60) Provisional application No. 62/950,467, filed on Dec. 19, 2019.

(51) Int. Cl. C08F 110/06

(52) U.S. Cl. CPC C08F 110/06

(57) ABSTRACT

The present disclosure provides methods for the production of polymer blends using multiple reactors arranged in parallel. The methods comprise: providing a first feed comprising propylene to a first reactor operated in parallel with a second reactor; catalytically converting the first feed in the first reactor under polymer formation conditions utilizing a first catalyst to form a first product mixture; separating the first product mixture into a first fraction comprising polypropylene and a second fraction comprising unreacted propylene; providing a second feed comprising one or more elastomeric monomers to the second reactor; catalytically converting the second feed in the second reactor under polymer formation conditions utilizing a second catalyst different from the first catalyst to form a second product mixture comprising an elastomeric polymer; and blending the first fraction with the second product mixture downstream from the first reactor and the second reactor to form a polymer blend.

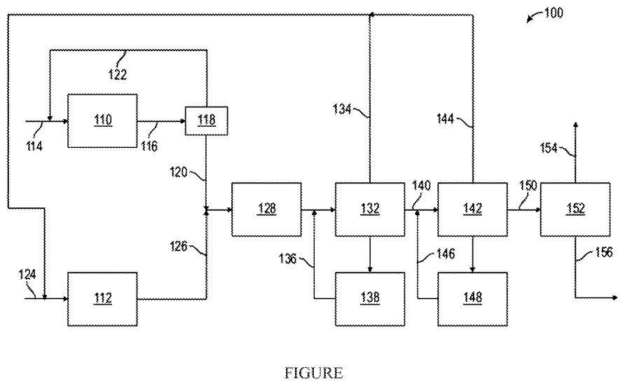

### CROSS-REFERENCE TO RELATED APPLICATIONS

This application claims priority to U.S. Ser. No. 62/950,467, filed Dec. 19, 2019, herein incorporated by reference.

### FIELD

The present disclosure generally relates to inline production of polymer blends.

### BACKGROUND

A common method to improve the toughness and impact resistance of isotactic polypropylene (iPP) has been the addition of elastomer components as a dispersed phase within a continuous phase of iPP. Two widely used elastomers for toughening iPP are ethylene-propylene rubber (EPR) and ethylene-propylene-diene rubber (EPDM). The resulting polymer blend is referred to as impact copolymer polypropylene (ICP), which affords improved toughness and impact resistance compared to isotactic polypropylene alone.

There are generally two methods introducing elastomers to iPP to form ICP. Compounding iPP with an elastomer by melt mixing of previously synthesized polymer components may be accomplished using heat and mechanical force. The other method used for producing ICP is commonly referred to as in-reactor blending, which includes first producing iPP in a first reactor and then embedding elastomers within the iPP in one or more following reactors arranged in series. The in-reactor blending method has several benefits over direct compounding of previously synthesized iPP and elastomers, although there are also disadvantages to this technique, as discussed below. Namely, there are significant energy savings due to elimination of the compounding step as well as beneficial morphology and performance improvements that may be realized with in-reactor blending. As a result, most commercial scale production of ICP is conducted using in-reactor blending.

The molecular weight distribution of both the iPP phase and the dispersed elastomer (rubber) phase, along with the distribution ratio of the ethylene and propylene in the rubber, can influence the performance characteristics of ICP. Broadening of the molecular weight distribution of the iPP phase may afford beneficial effects of the stiffness and drawability of ICP. A narrow composition distribution of elastomer components (e.g., about a 1:1 mole ratio of ethylene and propylene) in the rubber phase may afford a balance of stiffness and toughness in ICP. If the rubber is too propylene rich (i.e., ethylene to propylene monomer mole ratio <<1), the rubber may penetrate into and soften the iPP phase, thereby lowering stiffness of the ICP. If the rubber is too ethylene rich (i.e., ethylene to propylene monomer mole ratio >>1), poor compatibility of the rubber with the iPP may lead to larger dispersion domains and decrease the toughness of the ICP.

Because of the differing compositional requirements for the iPP and the rubber components comprising ICP, different catalysts are typically used to produce each component. For producing iPP having a wide molecular weight distribution, Ziegler-Natta catalysts are preferred since they have multiple active sites with differing polymerization activity values, thereby favoring the desired wide molecular weight distribution. EPR and EPDM, in contrast, may have a much narrower molecular weight distribution to optimize their elastomeric properties, and are more favorably produced using metallocene catalysts, which have a single active site.

Ziegler-Natta catalysts and metallocene catalysts are usually incompatible with one another, which generally precludes placing these catalysts in a single reactor to promote direct production of an ICP. The incompatibility of these two catalysts also creates significant difficulties in producing ICP via in-reactor blending using multiple reactors arranged in series. Namely, the Ziegler-Natta catalyst used to produce the iPP may be incorporated within a matrix of the iPP, such that both the iPP and the Ziegler-Natta catalyst are transported to a downstream reactor for producing the rubber component of the ICP. Once in the second reactor, the Ziegler-Natta catalyst may react with the elastomeric components (monomers) to produce an undesirably wide molecular weight distribution of the rubber. The transported Ziegler-Natta catalyst, in fact, may preclude use of a metallocene catalyst in the downstream reactor. Thus, the Ziegler-Natta catalyst leads to significant downstream process constraints for producing the rubber component. In many cases, optimized formulations cannot be realized in conventional ICP production processes.

Thus, there remains a need for ICP production processes that utilize both Ziegler-Natta and metallocene catalysts in a way that ICPs having optimized properties may be obtained.

### SUMMARY

The present disclosure provides methods for the production of polymer blends using multiple reactors arranged in parallel. The methods comprise: providing a first feed comprising propylene to a first reactor operated in parallel with a second reactor; catalytically converting at least a portion of the first feed in the first reactor under polymer formation conditions in the presence of a first catalyst to form a first product mixture comprising polypropylene, the first catalyst, and unreacted propylene; separating the first product mixture into a first fraction comprising the polypropylene and a second fraction comprising the unreacted propylene; returning at least a portion of the second fraction to the first reactor;

providing a second feed comprising one or more elastomeric monomers to the second reactor; catalytically converting at least a portion of the second feed in the second reactor under polymer formation conditions in the presence of a second catalyst different from the first catalyst to form a second product mixture comprising an elastomeric polymer; and blending the first fraction with the second product mixture downstream from the first reactor and the second reactor to form a polymer blend comprising polypropylene as a continuous phase and the elastomeric polymer as a discontinuous phase.

### BRIEF DESCRIPTION OF THE DRAWINGS

The following figure is included to illustrate certain aspects of the present disclosure, and should not be viewed as an exclusive embodiment. The subject matter disclosed is capable of considerable modifications, alterations, combinations, and equivalents in form and function, as will occur to one having ordinary skill in the art and having the benefit of this disclosure.

The Figure shows a simplified diagram of a reactor system featuring parallel reactors for producing polymer blends by downstream blending of reactor outputs according to the present disclosure.

### DETAILED DESCRIPTION

The present disclosure relates to production of impact copolymer polypropylene (ICP), and, more particularly, production of ICP using multiple reactors arranged in parallel.

As discussed above, the common commercial processes for producing ICP materials have inherent drawbacks such as the difficulty and expense of post-production melt-blending or the less than desirable ICP properties resulting from in-line blending using series reactors employing Ziegler-Natta catalysts. Common series reactor configurations do not easily lend themselves to utilizing different catalysts that may optimize the properties of the polymer components before a fully blended ICP is formed.

The present disclosure provides methods and reactor systems for producing ICP or similar polymer blends, in which a Ziegler-Natta catalyst and a metallocene catalyst may be used in parallel reactors. By using separate reactors in parallel according to the disclosure herein, ICP with more optimized properties may be realized by forming iPP with a preferred molecular weight distribution using a Ziegler-Natta catalyst and a rubber with preferred monomer ratios, morphologies, and molecular weights using a metallocene catalyst. The disclosed reactor system may allow advantageous in-line blending of the iPP and rubber to take place downstream of the reactors arranged in parallel, as discussed in more detail hereinafter.

There are numerous advantages to producing ICP and similar polymer blends with parallel reactors as described above. Ziegler-Natta and metallocene catalysts may be utilized simultaneously in independent parallel reactors under conditions optimal for each catalyst, thereby permitting the system to produce iPP with a desired broad distribution of molecular weight and EPR or another rubber/elastomeric polymer with a desired narrow molecular weight distribution. Producing EPR or another rubber with only the metallocene catalyst results in the EPR also having the desired narrow composition and molecular weight distribution in a desirable amorphous morphology. Utilizing separator recycle loops at elevated temperatures in the course of in-line blending downstream of the parallel reactors may improve the compounding of the iPP and EPR because blending may occur at the molecular level, thereby producing ICP with improved morphologies and material properties. The energy requirement to maintain the blended mixture at elevated temperatures during the separation and blending process may be less than that required to compound independently produced polymers (iPP and elastomeric polymer) by melt blending, thereby resulting in lower manufacturing costs. Other advantages may be further achieved by the present disclosure.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise.

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements. Ti, Zr, and Hf are Group 4 transition metals, for example.

For purposes of the present disclosure, polymer molecular weights are reported as the weight average molecular weight (Mw). The polydispersity index (PDI) calculated is the ratio of the weight average molecular weight (Mw) to the number average molecular weight (Mn). Unless otherwise noted, all molecular weights are in units of g/mol.

The term “hydrocarbon” refers to a class of compounds having hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Cₙ” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, or aromatic, with optional substitution being present in some cases.

The terms “hydrocarbyl” and “hydrocarbyl group” are used interchangeably herein. The term “hydrocarbyl group” refers to any Ci-Cioo hydrocarbon group bearing at least one unfilled valence position when removed from a parent compound. Suitable “hydrocarbyl” and “hydrocarbyl groups” may be optionally substituted. The term “hydrocarbyl group having 1 to about 100 carbon atoms” refers to an optionally substituted moiety selected from a linear or branched C₁-C₁₀₀ alkyl, a C₃-C₁₀₀ cycloalkyl, a C₆-C₁₀₀ aryl, a C₂-C₁₀₀ heteroaryl, a C₁-C₁₀₀ alkylaryl, a C₇-C₁₀₀ arylalkyl, and any combination thereof.

The term “substituted” refers to replacement of at least one hydrogen atom or carbon atom of a hydrocarbon or hydrocarbyl group with a heteroatom or heteroatom functional group. Heteroatoms may include, but are not limited to, B, O, N, S, P, F, Cl, Br, I, Si, Pb, Ge, Sn, As, Sb, Se, and Te. Heteroatom functional groups that may be present in substituted hydrocarbons or hydrocarbyl groups include, but are not limited to, functional groups such as O, S, S═O, S(═O)₂, NO₂, F, Cl, Br, I, NR₂, OR, SeR, TeR, PR₂, AsR₂, SbR₂, SR, BR₂, SiR₃, GeR₃, SnR₃, PbR₃, where R is a hydrocarbyl group or H. Suitable hydrocarbyl R groups may include alkyl, alkenyl, alkynyl, aryl, heteroaryl, cycloalkyl, heterocyclyl, and the like, any of which may be optionally substituted.

The term “optionally substituted” means that a hydrocarbon or hydrocarbyl group may be unsubstituted or substituted. For example, the term “optionally substituted hydrocarbyl” refers to replacement of at least one hydrogen atom or carbon atom in a hydrocarbyl group with a heteroatom or heteroatom functional group. Unless otherwise specified, any of the hydrocarbyl groups herein may be optionally substituted.

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Cy is cyclohexyl, Oct is octyl, Ph is phenyl, and Bn is benzyl.

Accordingly, the present disclosure provides methods for producing ICP and similar polymer blends using a system of parallel reactors, in which the methods may comprise: providing a first feed comprising propylene to a first reactor operated in parallel with a second reactor; catalytically converting at least a portion of the first feed in the first reactor under polymer formation conditions in the presence of a first catalyst to form a first product mixture comprising polypropylene, the first catalyst, and unreacted propylene; separating the first product mixture into a first fraction comprising the polypropylene and a second fraction comprising the unreacted propylene; returning at least a portion of the second fraction to the first reactor; providing a second feed comprising one or more elastomeric monomers to the second reactor; catalytically converting at least a portion of the second feed in the second reactor under polymer formation conditions in the presence of a second catalyst different from the first catalyst to form a second product mixture comprising an elastomeric polymer; and blending the first fraction with the second product mixture downstream from the first reactor and the second reactor to form a polymer blend comprising polypropylene as a continuous phase and the elastomeric polymer as a discontinuous phase. The polymer blend may comprise an ICP in various instances.

In more particular examples, the first catalyst may comprise a Ziegler-Natta catalyst and the second catalyst may comprise a metallocene catalyst. Suitable examples of Ziegler-Natta catalysts for producing a wide molecular weight distribution for polyolefins and metallocene catalysts for producing a narrow molecular weight distribution for polyolefins will be familiar to one having ordinary skill in the art.

In non-limiting examples, suitable metallocenes may be represented by Formula 1

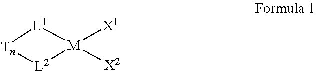

wherein M is a transition metal, often a group 4 metal, such as titanium, zirconium or hafnium; n is 0 or 1; T is an optional bridging group (T is absent if n is 0 and T is present if n is 1); L¹ and L² are independently cyclopentadienyl, substituted cyclopentadienyl, indenyl, substituted indenyl, tetrahydroindenyl, substituted tetrahydroindenyl, fluorenyl, or substituted fluorenyl groups; and X¹ and X² are, independently, anionic groups selected from hydrogen, halogen, hydrocarbyl, substituted hydrocarbyl, halocarbyl, substituted halocarbyl, silyl, silylcarbyl, substituted silylcarbyl, germylcarbyl, substituted germylcarbyl, aryl, substituted aryl, heteroaryl, substituted heteroaryl, alkoxy, substituted alkoxy, aryloxy, substituted aryloxy, boryl, amino, phosphino, ether, thioether, phosphine, amine, carboxylate, alkylthio, arylthio, 1,3-dionate, oxalate, carbonate, nitrate, or sulphate. Optionally, X¹ and X² may be joined and bound to the metal atom to form a metallacycle ring containing from about 3 to about 20 carbon atoms, or both together can be an olefin, diolefin or aryne ligand.

Particular examples suitable for bridging group T may include, but are not limited to, CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. More generally, bridging group T may be selected from dialkylsilyl, diarylsilyl, dialkylmethyl, diarylmethyl, methylene, hydrocarbyimethylene, ethylenyl, or hydrocarbylethylenyl, wherein one, two, three or four of the hydrogen atoms in ethylenyl may be substituted by a hydrocarbyl group

Particular examples of suitable metallocenes useful in the disclosure herein include, but are not limited to, the metallocenes disclosed and referenced in U.S. Pat. Nos. 7,179,876; 7,169,864; 7,157,531; 7,129,302; 6,995,109; 6,958,306; 6,884,748; 6,689,847; US Patent Application Publication 2007/0055028, and published PCT Applications WO 97/22635; WO 00/699/22; WO 01/30860; WO 01/30861; WO 02/46246; WO 02/50088; WO 04/026921; and WO 06/019494, each of which is fully incorporated herein by reference.

Examples of non-metallocene, Ziegler-Natta catalysts suitable for use in the disclosure herein include, but are not limited to, late transition metal pyridylbisimines (e.g., U.S. Pat. No. 7,087,686), group 4 pyridyldiamidos (e.g., U.S. Pat. No. 7,973,116), quinolinyldiamidos (e.g., US Patent Pub. No. 2018/0002352 A1), pyridylamidos (e.g., U.S. Pat. No. 7,087,690), phenoxyimines (e.g., Makio, H. et al. “Development and Application of FI Catalysts for Olefin Polymerization: Unique Catalysis and Distinctive Polymer Formation,” Accounts of Chemical Research, 2009, 42(10), pp. 1532-1544), and bridged bi-aromatic complexes (e.g., U.S. Pat. No. 7,091,292), the disclosures of which are incorporated herein by reference. It is to be appreciated that other structural classes of Ziegler-Natta catalysts may also be suitable for use in the disclosure herein, and the foregoing illustrative Ziegler-Natta catalysts should not be considered limiting of the scope of the present disclosure.

The one or more elastomeric monomers may comprise ethylene and propylene, as a non-limiting example. Optionally, the one or more elastomeric monomers may further comprise a diene monomer in some cases, such as dicyclopentadiene or ethylidene norbornene. Other olefinic elastomers formed using metallocene catalysis may also be suitably produced through application of the disclosure herein.

The polypropylene produced in the disclosure herein may comprise isotactic polypropylene (iPP). Other olefinic polymers formed using Ziegler-Natta catalysis may also be produced using the disclosure herein.

The blending may comprise transporting the polymer blend through at least one mixer and at least one separator. The polymer blend may be maintained in a molten state while passing through the at least one mixer and the at least one separator. Suitable mixers and separators will be familiar to one having ordinary skill in the art and are described in more detail below. In various aspects of the present disclosure, the first product mixture comprising the polypropylene may be exposed to a first (lead) separator before the polypropylene is further blended with the elastomeric polymer. Once the polypropylene and the elastomeric polymer have been combined, the resulting polymer blend may pass through at least one additional separator, more typically multiple separators operated at progressively decreasing pressures. A mixer, such as a static mixer, and a recycle loop may be associated with each separator used in compounding the polymer blend.

Methods of the present disclosure may further comprise: removing an overhead fraction from the at least one separator, specifically the at least one separator containing the polypropylene and elastomeric polymer in combination with one another, in which the overhead fraction comprises at least the one or more unreacted elastomeric monomers; and returning at least a portion of the overhead fraction to the second reactor. The overhead fraction returned to the second reactor may be combined with the feed entering the second reactor, or the overhead fraction may be introduced to the second reactor separately. As needed, the composition of the feed entering the second reactor may be adjusted in response to the composition of the overhead fraction being returned to the second reactor.

The methods of the present disclosure may also include the first product mixture being separated into the first fraction and the second fraction with a cyclone separator. The propylene in the second fraction may be returned to the first reactor, and the polypropylene in the first fraction may be further compounded with an elastomeric polymer produced in the second reactor according to the disclosure herein.

The second reactor may be a continuously stirred tank reactor, and polymerization may take place in a solution phase or in bulk. The second product mixture may initially comprise up to about fifty percent solvent by weight before being further compounded with polypropylene according to the disclosure herein. The solvent may be at least partially removed before being blended with the first product mixture.

Operating parameters of the first reactor may be optimized to produce an isotactic polypropylene having a weight average molecular weight of about 5,000 to about 500,000 or about 500,000 to about 10,000,000. Operating parameters of the second reactor may be optimized to produce an ethylene-propylene rubber or similar elastomeric polymer having a weight average molecular weight of about 100,000 to about 500,000. Operating parameters of the second reactor may be optimized to produce an ethylene-propylene rubber having an ethylene weight portion between about 20% to about 80%. Operating parameters of the first and second reactors may be optimized to produce an impact copolymer polypropylene having a weight portion of ethylene-propylene rubber between about 0% to about 80%.

Operating parameters of the first reactor may be optimized to produce an isotactic polypropylene having a PDI of at least about 2.6. Operating parameters of the second reactor may be optimized to produce ethylene-propylene rubber or similar elastomeric polymer having a PDI no greater than about 2.0.

The FIG. shows a simplified diagram of a reactor system featuring parallel reactors for producing polymer blends by downstream blending of reactor outputs according to the present disclosure. Reactor system 100 includes first reactor 110 and second reactor 112 operating in parallel and configured to catalytically convert olefin monomers into different polyolefin polymers. Different catalysts are employed in first reactor 110 and second reactor 112. When employed in a system for producing ICP, first reactor 110 may be a loop reactor utilizing slurry polymerization of propylene to produce iPP using a Ziegler-Natta catalyst. Likewise, second reactor 112 may be a continuously stirred tank reactor (CSTR) utilizing solution polymerization of propylene and ethylene to produce EPR or a similar elastomeric polymer using a metallocene catalyst. Other polyolefin elastomeric polymers may be produced similarly in second reactor 112.

Still referring to the FIG., first feed 114 comprising an olefin monomer is directed into first reactor 110. At least a portion of first feed 114 is catalytically converted within first reactor 110 under polymer formation conditions in the presence of a first catalyst, typically a Ziegler-Natta catalyst, to form a first product mixture. The first product mixture comprises at least the unreacted olefin monomer, the first catalyst, and a polyolefin polymer, such as polypropylene. First effluent 116 comprising the first product mixture passes from first reactor 110 to first separator 118, such as a hydrocyclone or similar cyclone separator. When reactor system 100 is utilized for ICP production, first effluent 116 comprising the first product mixture may include at least iPP and unreacted propylene from first reactor 110, each of which is received at first separator 118.

With continued reference to the FIG., first separator 118 may comprise a cyclone separator in various aspects of the present disclosure. Within first separator 118, the first product mixture is separated into first fraction 120 comprising the polyolefin polymer and a second fraction comprising the unreacted olefin monomer. First fraction 120 of the first product mixture is the output of first separator 118, which is further compounded downstream according to the disclosure provided hereinbelow. First recycle loop 122 provides a pathway for at least a portion of the overhead fraction or unreacted olefin monomer in the second portion separated in first separator 118 to return to first reactor 110 via first feed 114. When reactor system 100 is utilized in conjunction with ICP production, the cyclone separator permits the first effluent 116 to be separated into a first fraction comprising iPP powder and a second fraction comprising the unreacted propylene and other volatiles in the vapor phase, which is recycled back into first reactor 110 via first recycle loop 122. The residual weight balance of first effluent 116 may range from 0% to 50%, depending on the production rate, cyclone capacity, and recycle mass balance, for example. The employment of the cyclone separator on first effluent 116 is a significant factor to increase propylene conversion rates and satisfy the materials balance between makeup monomers and recycled volatiles.

Still referring to the FIG., second feed 124 comprising one or more elastomeric monomers, typically multiple olefin monomers, is directed into second reactor 112. At least a portion of second feed 124 is catalytically converted within second reactor 112 under polymer formation conditions in the presence of a second catalyst that is different from the first catalyst to form a second product mixture comprising an elastomeric polymer, typically an elastomeric polyolefin polymer such as ethylene-propylene rubber (EPR) or ethylene-propylene-diene monomer rubber (EPDM). As noted above, when employed in a system for producing ICP, second reactor 112 may be a continuously stirred tank reactor (CSTR) utilizing solution polymerization of propylene and ethylene to produce EPR or a similar elastomeric polymer using a metallocene catalyst. The elastomeric polymer may be obtained in a solution, which may comprise up to about 50% solvent by weight in some instances.

Second effluent 126 comprising the second product mixture passes from second reactor 112 and is combined with first fraction 120. The second product mixture may comprise at least EPR or a similar elastomeric polymer, unreacted propylene, unreacted ethylene, and the metallocene catalyst when the reactor system is used for ICP production. Likewise, as noted above, the first fraction may comprise at least iPP powder. Second effluent 126 comprising the second product mixture and first fraction 120 of the first product mixture are blended together in vessel 128, which may comprise a first static mixer configured to induce turbulent flow in the polymer blend. Other means of mixing may be used as well, such as stirred tank mixing. The resulting polymer blend is transported/pumped from vessel 128 to second separator 132. When producing ICP, the resulting polymer blend of iPP powder and EPR or a similar elastomeric polymer forms ICP comprising iPP in a continuous phase and EPR or a similar elastomeric polymer as an elastomeric discontinuous phase.

Once the polymer blend initially formed in vessel 128 enters second separator 132, additional separation of volatile components may begin. A first overhead fraction comprising at least one unreacted olefinic monomer received from either first reactor 110 or second reactor 112 may be removed via exhaust line 134, which may include a condenser (not shown) for feeding unreacted olefinic monomers back into second feed 124 for subsequent recycling into second reactor 112. Non-condensable materials in the first overhead fraction may be sent to a second stage condenser (not shown), or to another process in the refinery (not shown), or flaring may be conducted (not shown). While the polymer blend is being processed within second separator 132, it may be recirculated through recycle loop 136, which may include at least static mixer 138. Alternative means of mixing, such as stirred tank mixing, may also take place during recirculation. Continued compounding of the polymer blend in static mixer 138 and recycle loop 136 may enhance intermingling of the polymer chains and promote removal of the volatile components as the overhead fraction removed through exhaust line 134.

Optionally, output 140 of second separator 132 may then be transferred to third separator 142. Similar to the operation of separator 132, the polymer blend may be further processed in third separator 142 and recirculated through recycle loop 146, which may also include at least static mixer 148. Alternately, stirred tank mixing may take place within recycle loop 146. Likewise, exhaust line 144 may separate and return an overhead fraction comprising one or more unreacted olefinic monomers to second feed 124.

Further optionally, the polymer blend, as output 150 of third separator 142, may be received in fourth separator 152 for further processing. A third overhead fraction may be vented from fourth separator 152 via an exhaust line 154 to be further processed or flared. Output 156 transports/pumps the polymer blend from fourth separator 152 for further and/or final processing.

Although three separators downstream of first separator 128 are described herein (i.e., second separator 132, third separator 142, and fourth separator 152), it is contemplated that fewer or more separators may be present instead of those expressly depicted. Similarly, depending on particular process configurations, it is to be understood that not all separators are necessarily configured to return their overhead fraction to second feed 124.

It is contemplated that the temperature of the polymer blend may be elevated to maintain a molten state downstream from first reactor 110 and second reactor 112 when reactor system 100 is utilized for ICP production. It is also contemplated that the polymer blend may comprise the polymers dissolved and/or suspended in solvents after the initial blending downstream from first reactor 110 and second reactor 112. Thus, the polymer blend may only need to be maintained at an elevated temperature after one or more separation process steps in some instances. The operating temperatures of the separators may be about 160° C. to about 200° C. in many instances. First separator 118, which may be a cyclone separator, may be operated at the process pressure within first reactor 110 or may be higher or lower. It is contemplated that first separator 118 may be operated at a pressure of about 375 psi to about 500 psi. It is also further contemplated that first separator 118 may be operated at even higher pressures depending on the operating pressures of the downstream separators (i.e., separator 132 and optional separators 142 and 152). Downstream from first separator 118, subsequent separators may be operated at progressively decreasing pressures (i.e., separator 132 and optional separators 142 and 152). Second separator 132 may be a high-pressure separator operated at a pressure of about 150 psi to about 350 psi. Optional third separator 142 may be a low-pressure separator operated at a pressure of about 90 psi to about 100 psi. Finally, optional fourth separator 152 may be a vacuum separator operated at a working pressure of about 40 torr. After the separation process is complete and the polymer blend has been obtained, the finishing process of the ICP may be by any standardized methods or techniques. Other aspects of reactor system 100 may be developed in light of the present disclosure.

It is contemplated that reactor system 100 may produce EPR having a weight average molecular weight of about 100,000 to about 1,000,000 and iPP having a weight average molecular weight of about 5,000 to about 500,000. It is also contemplated that reactor system 100 may produce EPR or a similar elastomeric polymer having an ethylene content by weight of about 20% to about 80%. It is further contemplated that reactor system 100 as described above may produce ICP having an EPR content by weight of about 0.1% to about 80%.

It is to be appreciated that reactor system 100 has been simplified for purposes of this disclosure. Conventional equipment such as, but not limited to, pumps, heat exchangers, condensers, sensors, and any other required or standard production equipment have been excluded from the FIG. in the interest of clarity and simplicity. It is also contemplated that the number of reactors, separators, and static mixers is not fixed as disclosed in the FIG. There may be multiple parallel reactors beyond the two shown in the FIG. Also, there may be pre-polymerization reactors feeding first reactor 110, second reactor 112, or any number of other parallel reactors. The number of separators and associated recycle loops may also be dependent on the production rate and separator capacities and thus may be more or less than the number depicted. Each separator need not necessarily have a recycle loop and static mixer associated therewith. It is contemplated that reactor system 100 may be utilized for production of various types of polymer blends beyond ICP produced according to the disclosure herein. As such, production of ICP according to the disclosure herein should be considered a non-limiting example.

Embodiments disclosed herein include:

A. Methods comprising: providing a first feed comprising propylene to a first reactor operated in parallel with a second reactor; catalytically converting at least a portion of the first feed in the first reactor under polymer formation conditions in the presence of a first catalyst to form a first product mixture comprising polypropylene, the first catalyst, and unreacted propylene; separating the first product mixture into a first fraction comprising the polypropylene and a second fraction comprising the unreacted propylene; returning at least a portion of the second fraction to the first reactor; providing a second feed comprising one or more elastomeric monomers to the second reactor; catalytically converting at least a portion of the second feed in the second reactor under polymer formation conditions in the presence of a second catalyst different from the first catalyst to form a second product mixture comprising an elastomeric polymer; and blending the first fraction with the second product mixture downstream from the first reactor and the second reactor to form a polymer blend comprising polypropylene as a continuous phase and the elastomeric polymer as a discontinuous phase.

Embodiment A may have one or more of the following additional elements in any combination:

Element 1: wherein the first catalyst comprises a Ziegler-Natta catalyst and the second catalyst comprises a metallocene catalyst.

Element 2: wherein the one or more elastomeric monomers comprise at least ethylene and propylene.

Element 3: wherein the polypropylene comprises isotactic polypropylene.

Element 4: wherein blending comprises transporting the polymer blend through at least one mixer and at least one separator.

Element 5: wherein the polymer blend is maintained in a molten state while passing through the at least one mixer and the at least one separator.

Element 6: wherein the method further comprises: removing an overhead fraction from the at least one separator, the overhead fraction comprising at least one or more unreacted elastomeric monomers; and returning at least a portion of the overhead fraction to the second reactor.

Element 7: wherein at least two separators are operated at progressively decreasing pressures.

Element 8: wherein the first product mixture is separated into the first fraction and the second fraction with a cyclone separator.

Element 9: wherein the second product mixture initially comprises up to about fifty percent solvent by weight.

Element 10: wherein the second reactor is a continuous stirred tank reactor.

Element 11: wherein operating parameters of the first reactor are optimized to produce an isotactic polypropylene having a PDI of at least about 2.61 and operating parameters of the second reactor are optimized to produce ethylene-propylene rubber having a PDI no greater than about 2.0.

Element 12: wherein operating parameters of the first reactor are optimized to produce an isotactic polypropylene having a weight average molecular weight between about 5,000 to about 500,000.

Element 13: wherein operating parameters of the second reactor are optimized to produce an ethylene-propylene rubber having a weight average molecular weight between about 100,000 to about 500,000.

Element 14: wherein operating parameters of the second reactor are optimized to produce an ethylene-propylene rubber having an ethylene content by weight of about 20% to about 80%.

Element 15: wherein operating parameters of the first and second reactors are optimized to produce an impact copolymer polypropylene having an ethylene-propylene rubber content by weight of about 0.1% to about 80%.

By way of non-limiting example, exemplary combinations applicable to A include, but are not limited to: 1 and 2; 1 or 2 and 3; 1 or 2 and 4; 1 or 2 and 5; 1 or 2 and 6; 1 or 2 and 10; 1 or 2 and 11; 1 or 2 and 12; 1 or 2 and 13; 1 or 2 and 14; 1 or 2 and 15; 3 and 4; 3 or 4 and 5; 3 or 4 and 6; 3 or 4 and 6 and 7; 3 or 4 and 6 and 8; 3 or 4 and 6 and 7 and 9; 3 or 4 and 10; 3 or 4 and 11; 3 or 4 and 12; 3 or 4 and 13; 3 or 4 and 14; 3 or 4 and 15; 5 and 6; 5 and 6 and 7; 5 and 6 and 8; 5 and 7 and 9; 5 or 6 and 10; 5 or 6 and 11; 5 or 6 and 12; 5 or 6 and 13; 5 or 6 and 14; 5 or 6 and 15; 6 and 7 and 8; 6 and 7 and 9; 10 and 11; 10 or 11 and 12; 10 or 11 and 13; 10 or 11 and 14; 10 or 11 and 15; 12 and 13; 12 or 13 and 14; 12 or 13 and 15; and 14 and 15.

To facilitate a better understanding of the embodiments of the present disclosure, the following examples of preferred or representative embodiments are given. In no way should the following examples be read to limit, or to define, the scope of the invention.

### EXAMPLES

Process simulations were run using Aspen Plus version 10.0 simulation software with Aspen Polymer Module implemented. The thermodynamic method is based on Perturbed-Chain Statistical Association Fluid Theory (PC-SAFT). The required material properties are directly obtained from the property data banks implemented in Aspen Plus. The range of temperature, pressure, monomer and comonomer concentrations, etc., are designed based on an industrial scale ICP manufacturing process.

Simulations were run utilizing the reactor system exemplified by the FIG. and described above for producing ICP from iPP formed in a first reactor utilizing a Ziegler-Natta catalyst and EPR formed in a second parallel reactor utilizing a metallocene catalyst. The first reactor was a loop slurry reactor for producing the iPP. The second reactor was a CSTR for producing the EPR. A cyclone separator as the first separator and three vapor-liquid separators downstream of the first separator are modeled as based on the description above.

The reaction simulated in this example involves the copolymerization of ethylene and propylene to form EPR and homopolymerization of propylene to form iPP.

Copolymerization and homopolymerization kinetics are obtained from the literature and implemented in the simulation software. Ethylene is treated as the comonomer when making EPR. Both heat and mass balance and polymer properties, including chemical composition and molecular weight distribution can be accurately modeled.

A total of 16 cases were simulated covering four major variables in tuning the properties of ICP, including ethylene content of EPR, molecular weight of iPP, molecular weight of EPR, and weight fraction of EPR in ICP. The target values of these four variables are all designed according to commercial ICP products and processes.

Table 1 below summarizes the reactor conditions for both reactors in the simulation. The iPP polymer concentration produced by the loop slurry reactor ranged between 67.3% and 71.3% with propylene conversion rates ranging between 67.4% and 71.3%. The EPR polymer concentration produced by the CSTR ranged between 5.8% and 16.4% with ethylene conversion rates ranging between 24.8% and 75.4% and with propylene conversion rates ranging between 10.6% and 50.1%.

TABLE 1

| | Reactor 1 (iPP) | | | |
|---|---|---|---|---|
| | Temper- | Pres- | Polymer | Propylene |
| Case | ature | sure | Concen- | Con- |
| # | (° C.) | (psig) | tration | version |
| 1 | 70 | 520 | 67.3% | 67.4% |
| 2 | 70 | 520 | 67.3% | 67.4% |
| 3 | 70 | 520 | 69.1% | 69.2% |
| 4 | 70 | 520 | 69.1% | 69.2% |
| 5 | 70 | 520 | 69.8% | 69.8% |
| 6 | 70 | 520 | 69.8% | 69.8% |
| 7 | 70 | 520 | 71.3% | 71.3% |
| 8 | 70 | 520 | 71.3% | 71.3% |
| 9 | 70 | 520 | 67.3% | 67.4% |
| 10 | 70 | 520 | 67.3% | 67.4% |
| 11 | 70 | 520 | 69.1% | 69.2% |
| 12 | 70 | 520 | 69.1% | 69.2% |
| 13 | 70 | 520 | 69.8% | 69.8% |
| 14 | 70 | 520 | 69.8% | 69.8% |
| 15 | 70 | 520 | 71.3% | 71.3% |
| 16 | 70 | 520 | 71.3% | 71.3% |

| | Reactor 2 (EPR) | | | | |
|---|---|---|---|---|---|
| | Temper- | Pres- | Polymer | Ethylene | Propylene |
| Case | ature | sure | Concen- | Con- | Con- |
| # | (° C.) | (psig) | tration | version | version |
| 1 | 70 | 520 | 16.8% | 76.8% | 49.1% |
| 2 | 70 | 520 | 5.8% | 24.8% | 10.6% |
| 3 | 70 | 520 | 16.8% | 76.8% | 49.1% |
| 4 | 70 | 520 | 5.8% | 24.8% | 10.6% |
| 5 | 70 | 520 | 16.8% | 76.8% | 49.1% |
| 6 | 70 | 520 | 5.8% | 24.8% | 10.6% |
| 7 | 70 | 520 | 16.8% | 76.8% | 49.1% |
| 8 | 70 | 520 | 5.8% | 24.8% | 10.6% |
| 9 | 70 | 520 | 16.4% | 75.4% | 50.1% |
| 10 | 70 | 520 | 7.6% | 35.3% | 17.2% |
| 11 | 70 | 520 | 16.4% | 75.4% | 50.1% |
| 12 | 70 | 520 | 7.6% | 35.3% | 17.2% |
| 13 | 70 | 520 | 16.4% | 75.4% | 50.1% |
| 14 | 70 | 520 | 7.6% | 35.3% | 17.2% |
| 15 | 70 | 520 | 16.4% | 75.4% | 50.1% |
| 16 | 70 | 520 | 7.6% | 35.3% | 17.2% |

2 below summarizes the operating temperature and pressures of the three vapor-liquid separators modeled in the simulation. A high-pressure separator, a low-pressure separator, and a vacuum separator were modeled as described in the reactor system above. The cyclone separator processing the effluent from the reactor producing iPP was modeled as operating at a temperature of about 200° C. in the simulation. The high pressure separator was modeled as operating at about 130° C. and with pressures ranging from 185-350 pounds per square inch gage pressure. The temperature of the high pressure separator is acceptable because at this process point the polymers in the blended mixture are still at least partially dissolved and/or suspended in a solvent solution. As the solvent is removed the temperature of the process points downstream may need to be maintained at an elevated temperature to keep the polymer blend in a molten state. Thus, the low pressure and vacuum separators may be operated at progressively higher temperatures. The low pressure separator was modeled as operating at temperatures ranging between 160-180° C. and with pressures ranging from 90-100 pounds per square inch gage pressure. The vacuum pressure separator was modeled as operating at a temperature of about 200° C. and with a pressure of about 40 torr.

TABLE 2

| | High Pressure | | Low Pressure | | Vacuum | |
|---|---|---|---|---|---|---|
| | Temper- | Pres- | Temper- | Pres- | Temper- | Pres- |
| Case | ature | sure | ature | sure | ature | sure |
| # | (° C.) | (psig) | (° C.) | (psig) | (° C.) | (torr) |
| 1 | 130 | 350 | 160 | 100 | 200 | 40 |
| 2 | 130 | 350 | 165 | 100 | 200 | 40 |
| 3 | 130 | 350 | 160 | 100 | 200 | 40 |
| 4 | 130 | 350 | 165 | 100 | 200 | 40 |
| 5 | 130 | 200 | 180 | 100 | 200 | 40 |
| 6 | 130 | 290 | 170 | 100 | 200 | 40 |
| 7 | 130 | 200 | 180 | 100 | 200 | 40 |
| 8 | 130 | 290 | 170 | 100 | 200 | 40 |
| 9 | 130 | 350 | 170 | 100 | 200 | 40 |
| 10 | 130 | 280 | 180 | 100 | 200 | 40 |
| 11 | 130 | 350 | 170 | 100 | 200 | 40 |
| 12 | 130 | 280 | 180 | 100 | 200 | 40 |
| 13 | 130 | 185 | 180 | 90 | 200 | 40 |
| 14 | 130 | 210 | 180 | 90 | 200 | 40 |
| 15 | 130 | 185 | 180 | 90 | 200 | 40 |
| 16 | 130 | 210 | 180 | 90 | 200 | 40 |

Table 3 below summarizes the modeled properties of the polymer blends produced under the above simulation conditions.

TABLE 3

| | EPR | | | | | | |
|---|---|---|---|---|---|---|---|
| | Ethyl- | | | | | ICP | |
| | ene | | | iPP | | EPR | |
| Case | Con- | EPR | EPR | iPP | iPP | Con- | ICP |
| # | tent | Mw | PDI | Mw | PDI | tent | Mw |
| 1 | 21.9% | 156,642 | 2.00 | 125,379 | 2.66 | 18% | 131,158 |
| 2 | 20.1% | 247,671 | 2.00 | 125,379 | 2.66 | 17% | 146,142 |
| 3 | 21.9% | 156,642 | 2.00 | 201,489 | 2.61 | 18% | 193,360 |
| 4 | 20.1% | 247,671 | 2.00 | 201,489 | 2.61 | 17% | 209,177 |
| 5 | 21.9% | 156,642 | 2.00 | 111,438 | 2.74 | 44% | 131,426 |
| 6 | 20.1% | 247,671 | 2.00 | 111,438 | 2.74 | 41% | 166,759 |
| 7 | 21.9% | 156,642 | 2.00 | 198,475 | 2.69 | 43% | 180,384 |
| 8 | 20.1% | 247,671 | 2.00 | 198,475 | 2.69 | 40% | 218,014 |
| 9 | 40.7% | 155,955 | 2.00 | 125,379 | 2.66 | 18% | 130,753 |
| 10 | 41.2% | 250,216 | 2.00 | 125,379 | 2.66 | 18% | 147,949 |
| 11 | 40.7% | 155,955 | 2.00 | 201,489 | 2.61 | 17% | 193,642 |
| 12 | 41.2% | 250,216 | 2.00 | 201,489 | 2.61 | 18% | 210,127 |
| 13 | 40.7% | 155,955 | 2.00 | 111,438 | 2.74 | 42% | 130,153 |
| 14 | 41.2% | 250,216 | 2.00 | 111,438 | 2.74 | 43% | 171,449 |
| 15 | 40.7% | 155,955 | 2.00 | 198,475 | 2.69 | 41% | 180,992 |
| 16 | 41.2% | 250,216 | 2.00 | 198,475 | 2.69 | 42% | 220,358 |

Referring to Table 3 above, the ethylene content in EPR produced in the simulations ranged from about 20% to about 42% by weight. The weight average molecular weight of EPR ranged from about 150,000 to about 250,000. The content of EPR in the ICP ranged from about 17% to about 42% by weight. The weight average molecular weight of iPP produced in the simulations ranged from about 100,000 to about 200,000. Since the simulated EPR was produced with a metallocene catalyst having a single active site, the polydispersity index (PDI) of the EPR portion in the ICP was a narrow and desirable 2.00. The simulated iPP portions had broader molecular weight distributions, corresponding to a PDI range between about 2.61 and about 2.69, as a resulting of the Ziegler-Natta catalyst having multiple active sites.

Therefore, the simulation process shows that the present disclosure can successfully produce ICP using metallocene and Ziegler-Natta catalysts simultaneously in parallel reactors, ensuring design flexibility of the product components sufficient to achieve the optimal performance for a desired ICP product.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
providing a first feed comprising propylene to a first reactor operated in parallel with a second reactor;
catalytically converting at least a portion of the first feed in the first reactor under polymer formation conditions in the presence of a first catalyst to form a first product mixture comprising polypropylene, the first catalyst, and unreacted propylene;
separating the first product mixture into a first fraction comprising the polypropylene and a second fraction comprising the unreacted propylene;
returning at least a portion of the second fraction to the first reactor;
providing a second feed comprising one or more elastomeric monomers to the second reactor;
catalytically converting at least a portion of the second feed in the second reactor under polymer formation conditions in the presence of a second catalyst different from the first catalyst to form a second product mixture comprising an elastomeric polymer; and
blending the first fraction with the second product mixture downstream from the first reactor and the second reactor to form a polymer blend comprising polypropylene as a continuous phase and the elastomeric polymer as a discontinuous phase.

2. The method of claim 1, wherein the first catalyst comprises a Ziegler-Natta catalyst and the second catalyst comprises a metallocene catalyst.

3. The method of claim 1, wherein the one or more elastomeric monomers comprise at least ethylene and propylene.

4. The method of claim 1, wherein the polypropylene comprises isotactic polypropylene.

5. The method of claim 1, wherein blending comprises transporting the polymer blend through at least one mixer and at least one separator.

6. The method of claim 5, wherein the polymer blend is maintained in a molten state while passing through the at least one mixer and the at least one separator.

7. The method of claim 5, further comprising:
removing an overhead fraction from the at least one separator, the overhead fraction comprising at least one or more unreacted elastomeric monomers; and
returning at least a portion of the overhead fraction to the second reactor.

8. The method of claim 6, wherein at least two separators are operated at progressively decreasing pressures.

9. The method of claim 1, wherein the first product mixture is separated into the first fraction and the second fraction with a cyclone separator.

10. The method of claim 1, wherein the second product mixture initially comprises up to about fifty percent solvent by weight.

11. The method of claim 1, wherein the second reactor is a continuous stirred tank reactor.

12. The method of claim 1, wherein operating parameters of the first reactor are optimized to produce an isotactic polypropylene having a PDI of at least 2.61 and operating parameters of the second reactor are optimized to produce ethylene-propylene rubber having a PDI no greater than about 2.0.

13. The method of claim 1, wherein operating parameters of the first reactor are optimized to produce an isotactic polypropylene having a weight average molecular weight of about 5000 to about 500,000.

14. The method of claim 1, wherein operating parameters of the second reactor are optimized to produce an ethylene-propylene rubber having a weight average molecular weight of about 100,000 to about 500,000.

15. The method of claim 1, wherein operating parameters of the second reactor are optimized to produce an ethylene-propylene rubber having an ethylene weight portion of about 20% to about 80%.

16. The method of claim 1, wherein operating parameters of the first and second reactors are optimized to produce an impact copolymer polypropylene having a weight portion of ethylene-propylene rubber of about 0% to about 80%.
